(19) United States
(12) Patent Application Publication
(10) Pub. No.: US 2014/0216031 A1
(43) Pub. Date: Aug. 7, 2014

(54) SYSTEM FOR CONVERTING WASTE ENERGY INTO ELECTRICITY

(71) Applicant: James E. Hill, JR., Woodland Hills, CA (US)

(72) Inventor: James E. Hill, JR., Woodland Hills, CA (US)

(21) Appl. No.: 14/170,174

(22) Filed: Jan. 31, 2014

Related U.S. Application Data
(60) Provisional application No. 61/760,516, filed on Feb. 4, 2013.

(51) Int. Cl. F02G 1/02; F03G 6/06

(52) U.S. Cl. CPC F02G 1/02; F03G 6/06
USPC 60/641.14; 60/682

(57) ABSTRACT

A system and method for capturing waste heat and converting the captured waste heat into mechanical or electrical energy.

### CROSS-REFERENCES TO RELATED APPLICATIONS

This application claims priority from U.S. Provisional Application No. 61/760,516, filed Feb. 4, 2013 incorporated by reference in its entirety herein.

### BACKGROUND

According to a report published by Yale University, The United States has long used more energy for air conditioning than all other nations combined. As demand increases in the world's warmer regions, global energy consumption for air conditioning is expected to continue to rise dramatically and may have a major impact on climate change.

According to the U.S. Census Bureau, shipments of cooling and refrigeration equipment in the U.S. were valued at $16.8 billion in 2005. Of this amount, approximately $2.2 billion comprised large-scale central units.

At the time, analysts forecasted demand growth at 3.2% a year, which would have yielded a domestic market of $2.7 billion in 2012. Similarly, MarketLine estimated that the global HVAC market would reach $67.3 billion by 2012. In fact, because the world is warming, incomes are rising, and smaller families are living in larger houses in hotter places, a boom market for air conditioning developed with world sales in 2011 increased by 13 percent instead of the predicted 3.2 percent over 2010. That growth is expected to accelerate in coming decades.

It is estimated that worldwide residential, commercial, and industrial air conditioning consumes at least one trillion kilowatt-hours of electricity annually. In the U.S. alone, according to the United States Department of Energy (DOE), commercial buildings drew 332,981 gigawatt hours (GWH) of electricity for cooling in 2006. Commercial refrigeration drew another 111,693 GWH and industrial cooling processes drew a further 69,461 GWH for a total of 514,136 GWH allocable to commercial cooling, representing approximately 34.2% of total commercial sector demand for electricity. Vehicle air conditioners in the United States alone use 7 to 10 billion gallons of gasoline annually. Moreover, largely due to demand in warmer regions, it is possible that world consumption of energy for cooling could explode tenfold by 2050, giving climate change an unwelcome dose of extra momentum.

The United States has long consumed more energy each year for air conditioning than the rest of the world combined. In fact, we use more electricity for cooling than the entire continent of Africa, home to a billion people, consumes for all purposes. Between 1993 and 2005, with summers growing hotter and homes larger, energy consumed by residential air conditioning in the United States doubled, and leaped another 20 percent by 2010. The climate impact of air conditioning buildings and vehicles in the United States is now almost half a billion metric tons of carbon dioxide per year injected into the atmosphere. However, with other nations following our lead, America's century-long reign as the world cooling champion is coming to an end. If global consumption for cooling grows as projected to 10 trillion kilowatt-hours per year, equal to half of the world's entire electricity supply today, the climate forecast will be grim indeed.

The time window for debating the benefits and costs of air conditioning on a global scale is narrowing. Once a country goes down the air-conditioned path, it is very hard to change course. For example, China is already sprinting forward and is expected to surpass the United States as the world's biggest user of electricity for air conditioning by 2020. The number of U.S. homes equipped with air conditioning rose from 64 to 100 million between 1993 and 2009, whereas 50 million air-conditioning units were sold in China in 2010 alone. It is projected that the number of air-conditioned vehicles in China will reach 100 million in 2015, having more than doubled in just five years.

As urban China, Japan, and South Korea approach the air-conditioning saturation point, the greatest demand growth in the post-2020 world is expected to occur elsewhere, most prominently in South and Southeast Asia. India appears poised to predominate already. For example, about 40 percent of all electricity consumption in the city of Mumbai goes for air conditioning.

The Middle East is already heavily climate-controlled, but growth is expected to continue there as well. Within 15 years, Saudi Arabia could actually be consuming more oil than it exports, due largely to air conditioning. Furthermore, with summers continuing to warm, the United States and Mexico will continue increasing their heavy consumption of energy devoted to cool their businesses, residences and autos.

Countries are already struggling to keep up with peak power demand in hot weather. This summer, India is expecting a shortfall of 17 gigawatts, with residential electricity shut off for 16 hours per day in some areas. China is falling short by 30 to 40 gigawatts, resulting in energy rationing and factory closings.

In most countries, the bulk of electricity that runs air conditioners in homes and businesses is generated from fossil fuels, most prominently coal. In contrast, a large share of space heating in cooler climates is done by directly burning fuels, usually natural gas, other gases, or oil, all of which have somewhat smaller carbon emissions than coal. That, together with the energy losses involved in generation and transmission of electric power, means that on average, an air conditioner causes more greenhouse emissions when pushing heat out of a house than does a furnace when putting the same quantity of heat into a house.

Based on projected increases in population, income, and temperatures around the world, it is predicted that in a warming world, the increase in emissions from air conditioning will be faster than the decline in emissions from heating. As a result, the combined greenhouse impact of heating and cooling will begin rising soon after 2020 and then shoot up through the end of the century.

If conventional present day air conditioning and refrigeration technologies for existing and future system installations are not upgraded or modified to reduce electricity consumption immediately, the aforementioned facts and predictions lead one to believe that many results can occur that will be detrimental to the world's environmental and economic well-being. Further, waste heat expelled by ventilation systems from hot attics, water heaters, furnaces, dryers, and the like are vented to the atmosphere to only further contribute to the global heating problem.

What has been needed, and previously unavailable, is a system and method that provides for upgrading and modification of conventional present day air conditioning and refrigeration technologies for existing and future system installations to reduce the waste of thermal energy to our atmosphere by capturing such thermal energy from waste heat ventilation systems for, but not limited to, the following systems such as air conditioning and refrigeration condensing units, water heaters, furnaces, hot attic ventilation systems, dryer vents, and the like for residential, commercial and industrial applications. Such a system would be capable of converting the thermal energy from the aforementioned systems to mechanical and/or electric energy that can significantly reduce the need for power consumption from external electricity generation plants, therefore reducing the pertinent need for fossil fuels (primarily coal) and the resulting CO2 and other harmful emissions that are injected into the earth's environment. Such a system would also be advantageous in that power providers will save the money that otherwise would have been necessary to up scale the electricity infrastructure to meet the increased demand for electricity from air conditioning and refrigeration power consumption, which may also result in a reduction in the energy and/or power bills of end users of the air conditioning and refrigeration systems. The present invention satisfies these and other needs.

### SUMMARY OF THE INVENTION

In a most general aspect, the present invention includes an assembly that may be installed on any waste heat and/or condensing unit to recapture thermal energy expelled by the unit and to convert the waste thermal energy into mechanical or electrical energy. In one aspect, this is accomplished by installing a sealed plenum and/or a pressure transition cone/tube to a waste heat rejection system fan exit or shroud, capturing and concentrating the pressure or thermal energy discharged from the waste heat rejection system and/or condensing unit and using the captured energy to generate electricity.

In another general aspect, the present invention includes an assembly that can be installed on any waste heat rejection system and/or condensing unit to recapture such heat energy and convert part or all of the waste heat energy into mechanical energy by means of installing a sealed plenum and/or a pressure transition cone/tube to a waste heat rejection system fan exit/shroud which captures and concentrates the pressure and/or thermal energy contained in the fluid/gas which contains the waste heat energy that is also being discharged from the waste heat rejection system and/or condensing unit.

In another aspect, the waste heat is captured using an expansion turbine that converts the thermal energy to mechanical energy which, in some aspects, may be used to drive a power/work generation device such as a generator or compressor.

In yet another aspect, the invention includes a system for converting waste heat into mechanical energy, comprising: a waste heat source; a concentrating cone having a first end have a first opening having a first size and a second end having a second opening having a second size less than the first size; a turbine mounted in fluid communication with the second opening of the concentrating cone; and an impeller driven by a motor, the impeller configured to expose a heat exchange fluid to the waste heat source such that the heat exchange fluid is heated by the waste heat source and to drive the heat exchange fluid into the first opening of the concentrating cone where the heat exchange fluid is concentrated by the concentrating cone and then driven through the second opening of the concentrating cone to drive the turbine. In one alternative aspect, the heat exchange fluid is a gas. In an alternative aspect, the gas is air. In a further aspect, the turbine is in mechanical communication with a generator.

In still another aspect, the invention further comprises a solar reflector that is disposed about a portion of the concentrating cone to reflect solar radiation onto the concentrating cone. In a further aspect, the invention further comprises an insulating shell disposed around the concentrating cone, the insulating shell decreasing the amount of thermal energy lost from an interior of the concentrating cone to an exterior of the concentrating cone. In still a further aspect, the invention may also include a heat absorbent material disposed on an exterior of the concentrating cone. In one alternative aspect, the heat absorbent material is black paint.

In yet another aspect, the invention further comprises a housing surrounding the fan and motor, the housing having a first opening and a second opening; wherein the first opening is in fluid communication with the waste heat source and the second opening of the housing is in fluid communication with the first opening of the concentrating cone.

In an alternative aspect, the housing includes a third opening, the third opening configured to receive heated fluid from a second waste heat source separate from the first waste heat source. In still another alternative aspect, the second source of waste heat separate from the first waste heat source is at least one waste heat source selected from the group consisting of an attic, a furnace, a boiler, a hot water heater, a stove vent, and a clothes dryer. In yet another alternative aspect, the waste heat source is a heat exchanger of a refrigeration system. In another alternative aspect, the waste heat source is a waste heat rejection system.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a perspective side view of an embodiment of the present invention for capturing waste heat energy, condensing the heat energy and using the condensed heat energy to drive a turbine to convert the waste heat energy into mechanical energy.

FIG. 2 is a schematic representation of the embodiment of FIG. 1 further including a generator for converting the mechanical energy into electrical energy.

FIG. 3 is a perspective side view of another embodiment of the present invention illustrating the use of a reflective solar dish to reflect and concentrate solar energy to increase the amount of heat energy converted into mechanical energy by the turbine.

FIG. 4 is a perspective side view of another embodiment of the present invention illustrating a modification of the embodiment of FIG. 1 to capture waste heat energy from a space such as an attic where hot air collects and needs to be vented, and/or waste heat from another heat generating system, such as a dryer or hot water heater, furnace, boiler and the like.

### DETAILED DESCRIPTION OF THE PREFERRED EMBODIMENTS

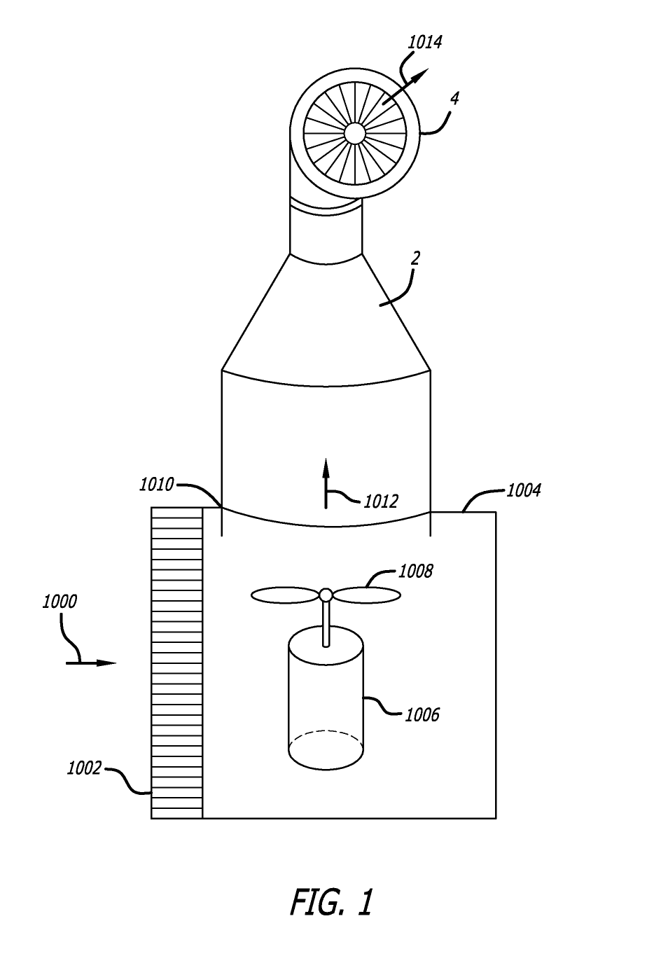

Referring now to the drawings in detail, in which like reference numerals indicate like or corresponding elements among the several figures, there is shown in FIG. 1 an embodiment of the present invention having an assembly for capturing waste heat and flow energy from a hot fluid stream that is exhausted into a vent or pipe and converting the waste heat and flow energy of the hot fluid stream into mechanical energy.

As shown in FIG. 1, a fluid, such as water or other liquid, or air or other gas 1000 is directed through a refrigerated condensing unit and/or a waste heat rejection system 1004, where the fluid 1000 exchanges heat energy with the condenser coil 1002. In this embodiment, fluid 1000 is drawn through coil 1002 by a fluid flow generated by the revolution of fan 1008 driven by fan motor 1006. In this embodiment, the fluid 1000 cools the refrigerant flowing through coil 1002 by removing heat from the coil 1002. The removed heat increases the temperature, and thus the amount of heat energy contained in fluid 1000, resulting in heated and/or pressurized fluid 1012. Those skilled in the art will also appreciate that fan motor 1006 also adds thermal energy to fluid 1000 because of the heat generated by the less than 100% conversion of electrical energy into mechanical energy by the motor, along with a small amount of thermal energy caused by the interaction of the blades of fan 1006 with the molecules of the fluid, and that this additional thermal energy may also be recaptured from the heated and/or pressurized fluid 1012.

Heated fluid 1012 is then discharged via a fan exit or shroud 1010 into a pressure transition cone or tube 2 where the volume of heated fluid 1012 is concentrated before the heated fluid 1012 enters an expansion turbine 4 where waste heat thermal energy is extracted and converted to mechanical energy and fluid 1012 is cooled and discharged as discharged fluid 1016.

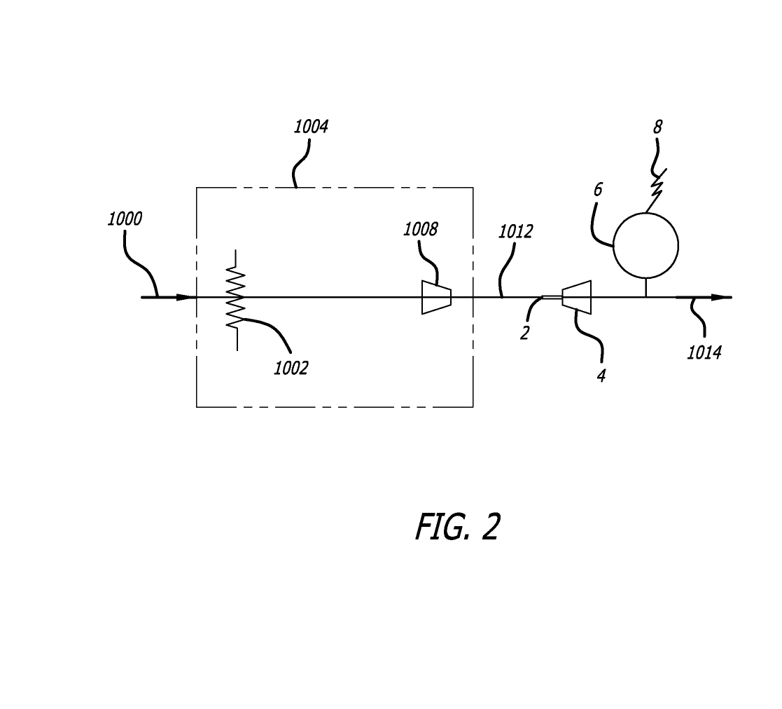

FIG. 2 is a schematic diagram of an embodiment of the present invention wherein an electric generator 6 is interconnected and driven by the expansion turbine 4 (FIG. 1). As shown in the diagram, fluid 1000 is drawn through the condenser 1002 by fan 1008. Once fluid is drawn through condenser 1002, it is heated and becomes heated fluid 1012 which is then concentrated by flowing through cone 2, driving turbine 4. The shaft of turbine 4 is in mechanical communication with generator 6 which in turn generates electrical energy 8.

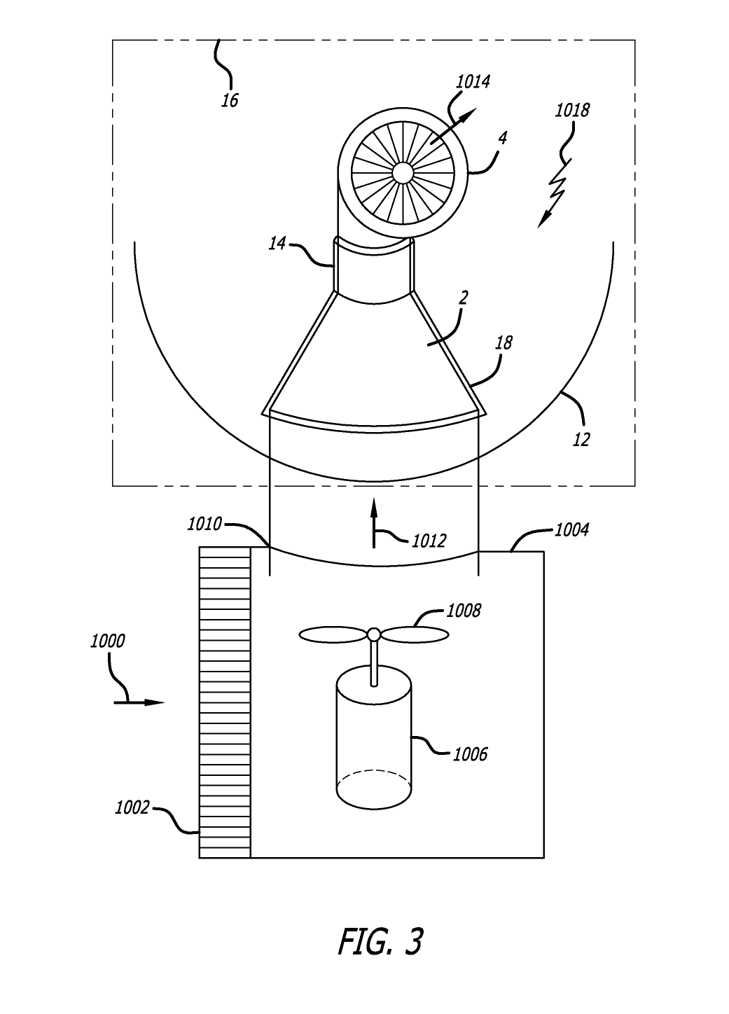

FIG. 3 is a perspective side view of another embodiment of the present invention similar to that described above with reference to FIG. 1, but including a concentrating solar collector subassembly 16. In this embodiment, pressure transition cone or tube 2 penetrates and/or is surrounded by a reflective solar dish or trough 12 that is configured to reflect and concentrate solar radiation 1018 onto the cone or tube 2, heating the cone and thus the fluid passing through the cone before the heated fluid 1012 is directed through turbine 4.

In another embodiment, the cone, or a portion of the cone may be covered with a heat absorption coating 14 to further heat the fluid 1012 as it passes through the cone or tube 2 to drive turbine 4. Heat absorption coating 14 may be a black paint, polymer or other coating that is capable of absorbing solar radiation and converting the solar radiation to heat, and then transferring the heat to the cone or tube 2. Additionally, the cone or tube 2 may also be surrounded by a glass vacuum tube shell 18 that can insulate the cone or tube 2 and thus maintain the temperature of the fluid flowing through cone or tube 2.

Preventing heat loss from heated fluid 1012 before it reaches turbine 4 can decrease density and increase upward vertical velocity or pressure, temperature and enthalpy of heated fluid 1012 prior to entry into expansion turbine 4. Hence, more enthalpy can be extracted from heated fluid 1012 and thereby converted to energy to increase the output of a conversion device, such as electric generator 6 (FIG. 2), coupled to turbine 4. One skilled in the art will understand that all of the above embodiments may be used individually, or combined in a variety of combinations as required, and are intended to be within the scope of the invention.

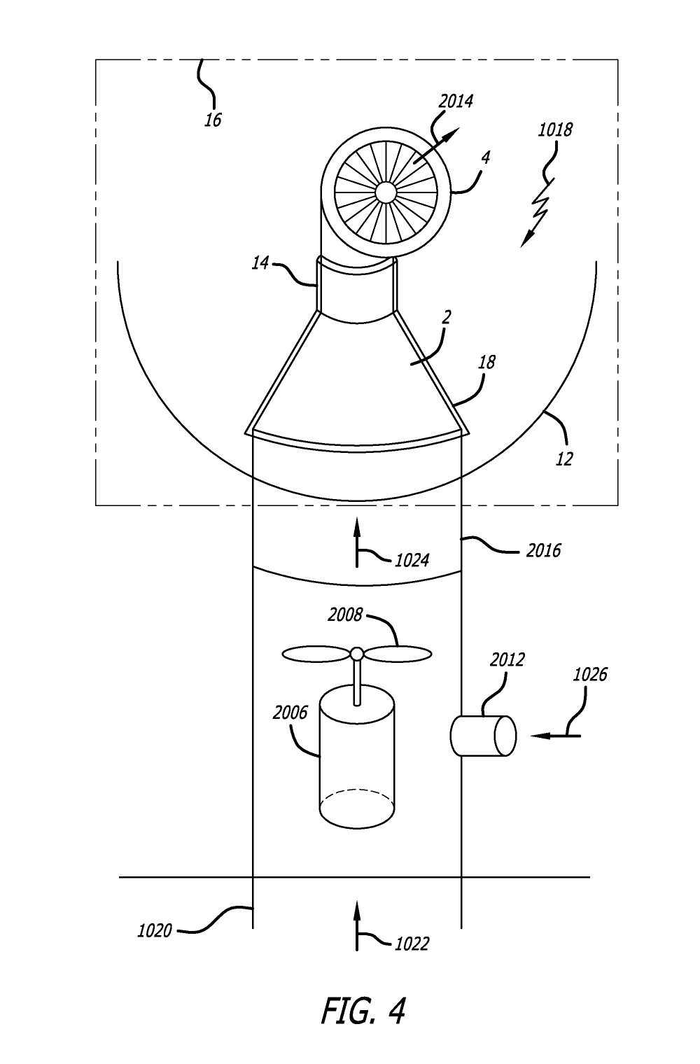

FIG. 4 is a perspective side view of a further embodiment wherein the various embodiments of the present invention described above can be used in conjunction with other systems or appliances that generate waste heat to recapture the energy in that waste heat. In the embodiment shown, for example, a fan 2008 driven by motor 2006 draws air 1022 from an attic. As commonly known, air within an attic is typically heated to a high temperature by the solar radiation falling upon a roof, as well as by thermal leakage from inside the structure covered by the attic and roof.

As described above, air 1022 may also be further heated by waste heat from motor 2006 and interaction with the blades of fan 2008, resulting in exhaust air 1024, which is then directed through concentration cone or tube 2 to turbine 4, where it is finally exhausted as exhaust air 2014. As described with reference to FIG. 3, cone or tube 2 may also be surrounded by solar reflector 12, which may also be combined with vacuum tube 18 and/or heat absorbing coating 14 to increase the efficiency of the system.

In still another embodiment, heated air 1026 containing waste heat may also be collected by the system through vent pipe or tube 2012. In this embodiment, waste heat from a furnace flue, boiler, hot water heater, clothes dryer or other heat generating appliance may be drawn into system to maximize thermal energy/enthalpy available to be converted to mechanical work and/or power by turbine 4.

The various embodiments of the invention are advantageous in that they provide a system and method for capturing the energy contained in waste heat that would otherwise be lost, and converting at least a portion of this waste heat into something useful, such as electricity or mechanical energy that can be used to operate various mechanical devices. Moreover, the embodiments of the invention are relatively uncomplicated, and thus may be inexpensively implemented. The efficiency of the embodiments of the invention may also be enhanced, as set forth above. Thus, the various embodiments of the invention are useful not only in the United States, but elsewhere in the world. They are particularly useful in areas where the environment itself may be used to enhance the efficiency of the system, such as where copious sunlight may be used to further add heat the system before the waste heat is converted into mechanical or electrical energy.

While several particular forms of the invention have been illustrated and described, it will be apparent that various modifications can be made without departing from the spirit and scope of the invention.

I claim:

1. A system for converting waste heat into mechanical energy, comprising:
a waste heat source;
a concentrating cone having a first end have a first opening having a first size and a second end having a second opening having a second size less than the first size;
a turbine mounted in fluid communication with the second opening of the concentrating cone; and
an impeller driven by a motor, the impeller configured to expose a heat exchange fluid to the waste heat source such that the heat exchange fluid is heated by the waste heat source and to drive the heat exchange fluid into the first opening of the concentrating cone where the heat exchange fluid is concentrated by the concentrating cone and then driven through the second opening of the concentrating cone to drive the turbine.

2. The system of claim 1, wherein the heat exchange fluid is a gas.

3. The system of claim 2, wherein the gas is air.

4. The system of claim 1, wherein the turbine is in mechanical communication with a generator.

5. The system of claim 1, further comprising a solar reflector that is disposed about a portion of the concentrating cone to reflect solar radiation onto the concentrating cone.

6. The system of claim 1, further comprising an insulating shell disposed around the concentrating cone, the insulating shell decreasing the amount of thermal energy lost from an interior of the concentrating cone to an exterior of the concentrating cone.

7. The system of claim 1, further comprising a heat absorbent material disposed on an exterior of the concentrating cone.

8. The system of claim 7, wherein the heat absorbent material is black paint.

9. The system of claim 1, further comprising a housing surrounding the fan and motor, the housing having a first opening and a second opening;
wherein the first opening is in fluid communication with the waste heat source and the second opening of the housing is in fluid communication with the first opening of the concentrating cone.

10. The system of claim 9, wherein the housing includes a third opening, the third opening configured to receive heated fluid from a second waste heat source separate from the first waste heat source.

11. The system of claim 10, wherein the second source of waste heat separate from the first waste heat source is at least one waste heat source selected from the group consisting of an attic, a furnace, a boiler, a hot water heater, a stove vent, and a clothes dryer.

12. The system of claim 1, wherein the waste heat source is a heat exchanger of a refrigeration system.

13. The system of claim 1, wherein the waste heat source is a waste heat rejection system.

14. The system of claim 7, wherein the heat absorbent material is a polymer.
